(19) United States
(12) Patent Application Publication
(10) Pub. No.: US 2018/0251993 A1
(43) Pub. Date: Sep. 6, 2018

(54) LEAF REMOVAL CONVEYOR DEVICE FOR POOL SKIMMER

(71) Applicant: ERUPTECH LLC, Atlanta, GA (US)

(72) Inventor: John IRVINE, Atlanta, GA (US)

(73) Assignee: ERUPTECH LLC, Atlanta, GA (US)

(21) Appl. No.: 15/909,305

(22) Filed: Mar. 1, 2018

Related U.S. Application Data
(60) Provisional application No. 62/465,880, filed on Mar. 2, 2017.

(51) Int. Cl. E04H 4/16; B65G 15/44; B65G 65/00; B65G 65/42; B65G 15/60; E04H 4/12

(52) U.S. Cl. CPC E04H 4/16; B65G 15/44; E04H 4/1272; B65G 65/42; B65G 15/60; B65G 65/005

(57) ABSTRACT

A leaf removal conveyor for a pool skimmer designed to remove leaves and debris from a pool skimmer and skimmer basket and deposit the debris in a collection container. The leaf removal conveyor generally includes a conveyor housing and a collection container for retaining leafs and other debris. The conveyor housing generally includes a belt and a drive mechanism at least partially surrounded by an outer shell. The conveyor housing is configured to extend through an access opening in a pool deck to a skimmer basket. The belt is configured to move leafs and debris from the skimmer basket, through the conveyor housing to the collection container.

### CROSS-REFERENCE TO RELATED APPLICATION

This application claims the benefit of U.S. Provisional Patent Application Ser. No. 62/465,880 filed Mar. 2, 2017, the entirety of which is hereby incorporated herein by reference for all purposes.

### TECHNICAL FIELD

The present invention relates generally to the field of swimming pool cleaning devices, and more particularly to a leaf removal device for pool skimmers.

### BACKGROUND

Swimming pools often include a filtering system with one or more inlets, a pump system, and one or more outlets. In order to prevent debris, such as leaves or sticks, from entering the pump system, the inlets generally include a skimmer which collects the debris in a basket set into a cavity within the inlet. These baskets fill with debris and need to be emptied often and by hand.

Previously designed systems to automatically remove leaves and debris from the skimmer often require the skimmer basket be removed from the skimmer, increasing the risk that debris enters the pump system. Previously known systems can also be unwieldy to install and operate, and can be of limited effectiveness in removing debris.

Accordingly, it can be seen that needs exist for an improved leaf removal system for swimming pools skimmers. It is to the provision of an improved leaf removal device or system meeting these and other needs that the present invention is primarily directed.

### SUMMARY

In example embodiments, the present invention provides a leaf removal conveyor for a pool skimmer designed to remove leaves and debris from a pool skimmer and skimmer basket and deposit the debris in a collection container. The leaf removal conveyor generally includes a conveyor housing and a collection container for retaining leafs and other debris. The conveyor housing generally includes a belt and a drive mechanism at least partially surrounded by an outer shell. The conveyor housing is configured to extend through an access opening in a pool deck to a skimmer basket. The belt is configured to move leafs and debris from the skimmer, through the conveyor housing to the collection container.

In an example embodiment, the invention relates to a leaf removal conveyor system for use with a pool skimmer including a skimmer basket, the conveyor system including a belt and a drive mechanism. The belt includes at least one cleat configured to move in a cyclical motion within an enclosure. At least a portion of the enclosure is configured to engage with a pool skimmer. The drive mechanism is configured to move the belt in a cyclical motion moving the at least one cleat through the skimmer to collect and remove debris.

In another example embodiment, the invention relates to a leaf removal conveyor system for use with a pool skimmer comprising a skimmer opening and skimmer basket, the leaf removal conveyor comprising a conveyor housing, a belt, and a drive mechanism. The conveyor housing is configured to extend through the skimmer opening. A portion of the conveyor housing rests on a rim of the skimmer basket and a portion of the conveyor housing is positioned within the skimmer basket. The belt includes at least one cleat configured to move in a cyclical motion within the conveyor housing. The drive mechanism is configured to move the belt in a cyclical motion moving the at least one cleat through the skimmer basket to collect and remove debris.

In still another example embodiment, the invention relates to a method of removing leaves and debris from a pool skimmer having a skimmer opening and a skimmer basket. The method includes inserting a conveyor housing through the skimmer opening into the skimmer. The conveyor housing comprises a belt with at least one cleat, a drive mechanism, and a sensor configured to determine when leaves and debris are present in the skimmer. The method further comprises sending a relay signal from the sensor to the drive mechanism when leaves and debris are detected in the skimmer then having the relay signal activate the drive mechanism to turn the belt in a circular motion wherein the cleats remove the debris from the skimmer. Lastly, the method comprises collecting the debris removed from the skimmer in a collection container.

In still another example embodiment, the invention relates to a leaf removal conveyor system for use with a pool skimmer, the leaf removal conveyor comprising an elongate housing, a belt, and a drive mechanism. The elongate housing has a intake opening in a bottom end of the housing and an exit opening in the top end of the housing. The bottom end of the housing is configured to be inserted into the pool skimmer and a portion of the housing behind the intake opening is perforated. The belt includes at least one cleat configured to move in a circular motion within the housing. The drive mechanism configured to move the belt moving the at least one cleat through the skimmer to collect and remove debris.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of leaf removal conveyor device for a pool skimmer according to an example embodiment of the present invention.

FIG. 2 is a perspective view of the leaf removal conveyor device of FIG. 1.

FIG. 3 is a top view of the leaf removal conveyor device of FIG. 1.

FIG. 4 is a side view of the leaf removal conveyor device of FIG. 1.

FIG. 5 is a side cross-sectional view of the leaf removal conveyor device of FIG. 1.

FIG. 6 is a perspective view of the belt of the leaf removal conveyor device of FIG. 1.

FIG. 7 is a detailed perspective view of the belt of FIG. 6.

FIG. 8 is a detailed perspective view of the motor housing of the leaf removal conveyor device of FIG. 1.

FIG. 9 is a perspective rear view of the conveyor housing of the leaf removal conveyor device of FIG. 1.

FIG. 10 is a detailed perspective view of the top of the conveyor housing of FIG. 9.

FIG. 11 is a detailed perspective view of the bottom of the conveyor housing of FIG. 9.

FIG. 12 is a detailed perspective view of the bottom of the conveyor housing of FIG. 9.

FIG. 13 is a detailed perspective view of the bottom of the conveyor housing of FIG. 9.

FIG. 14 is a detailed perspective view of the bottom of the conveyor housing of FIG. 9.

FIG. 15 is a detailed perspective view of the positioning wedge of the leaf removal conveyor device of FIG. 1.

FIG. 16 is a perspective view of a mode of use of the leaf removal conveyor device of FIG. 1.

FIG. 17 is a detailed perspective view of the bottom of a leaf removal conveyor device according to another example embodiment of the present invention.

FIG. 18 is a detailed perspective view of the bottom of the leaf removal conveyor device of FIG. 17.

FIG. 19 is a side cross-sectional view of a leaf removal conveyor device according to another example embodiment of the present invention.

FIG. 20 is a side cross-sectional view of the bottom a leaf removal conveyor device according to another example embodiment of the present invention.

FIG. 21 is a front view of the bottom of the leaf removal conveyor device of FIG. 20.

FIG. 22 is a perspective view of the bag of a leaf removal conveyor device according to another example embodiment of the present invention.

FIG. 23 is a bottom perspective view of the bag of FIG. 22.

FIG. 24 is a side perspective view of the bag of FIG. 22.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

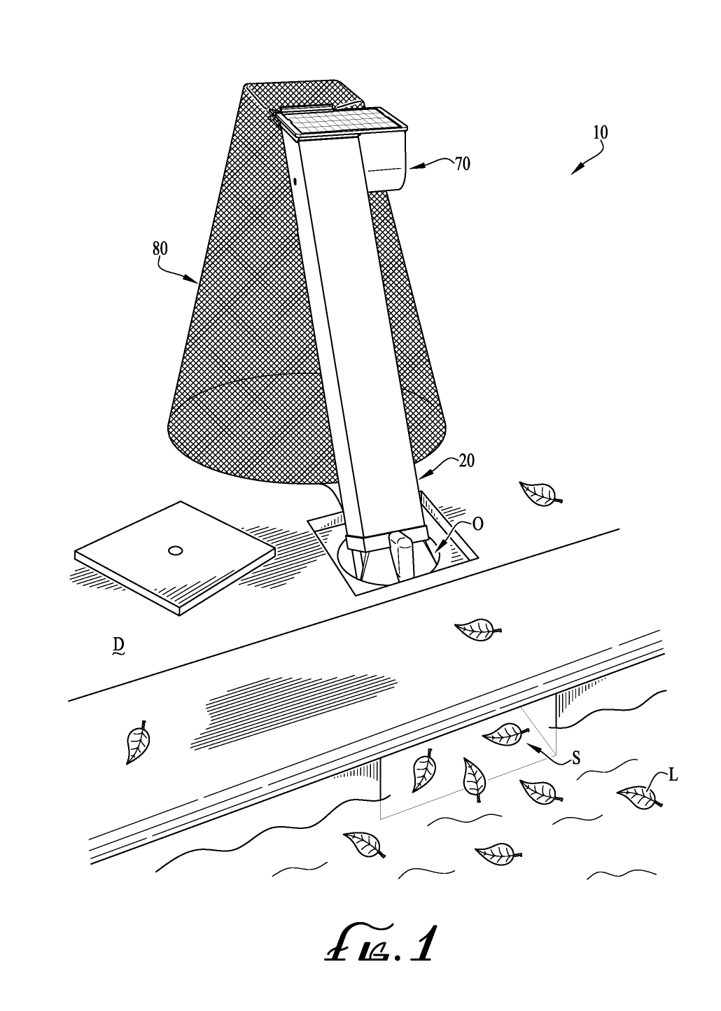

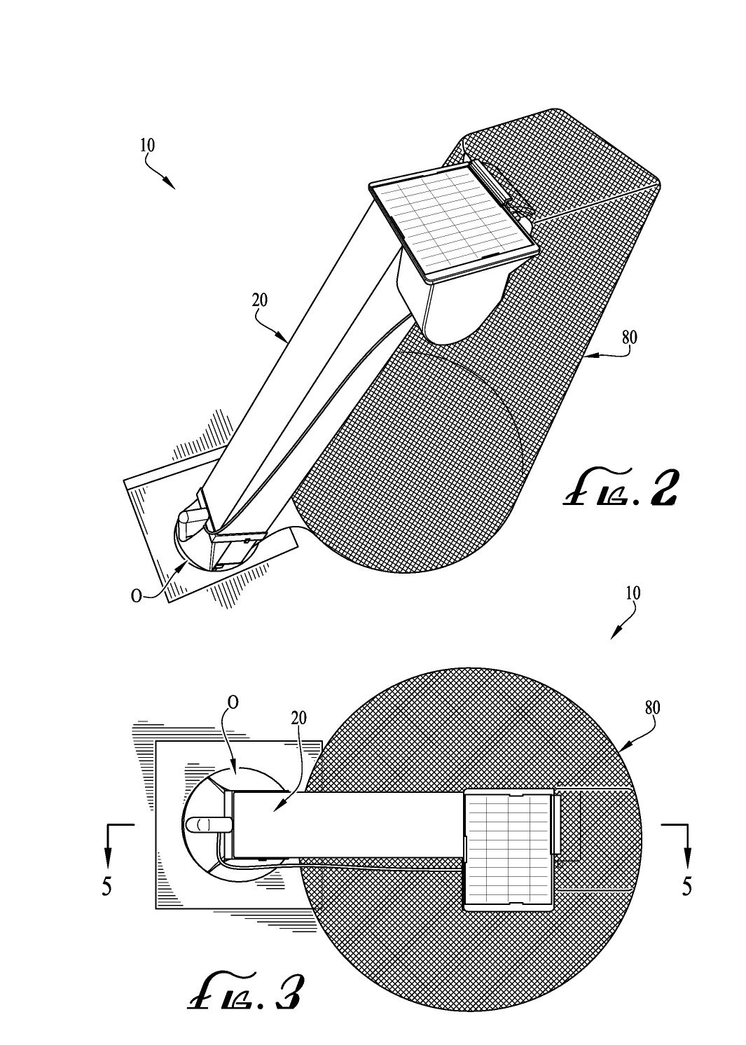

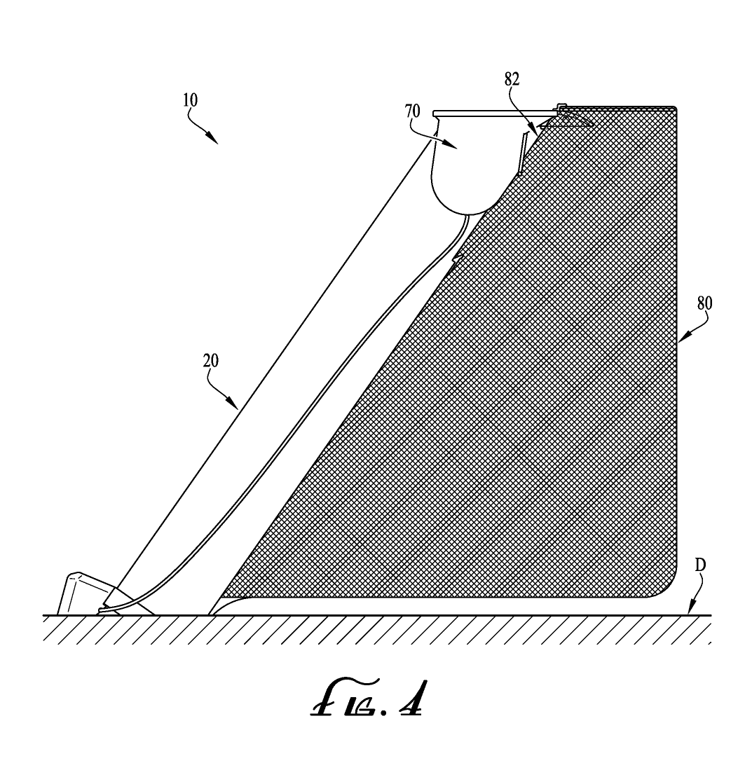

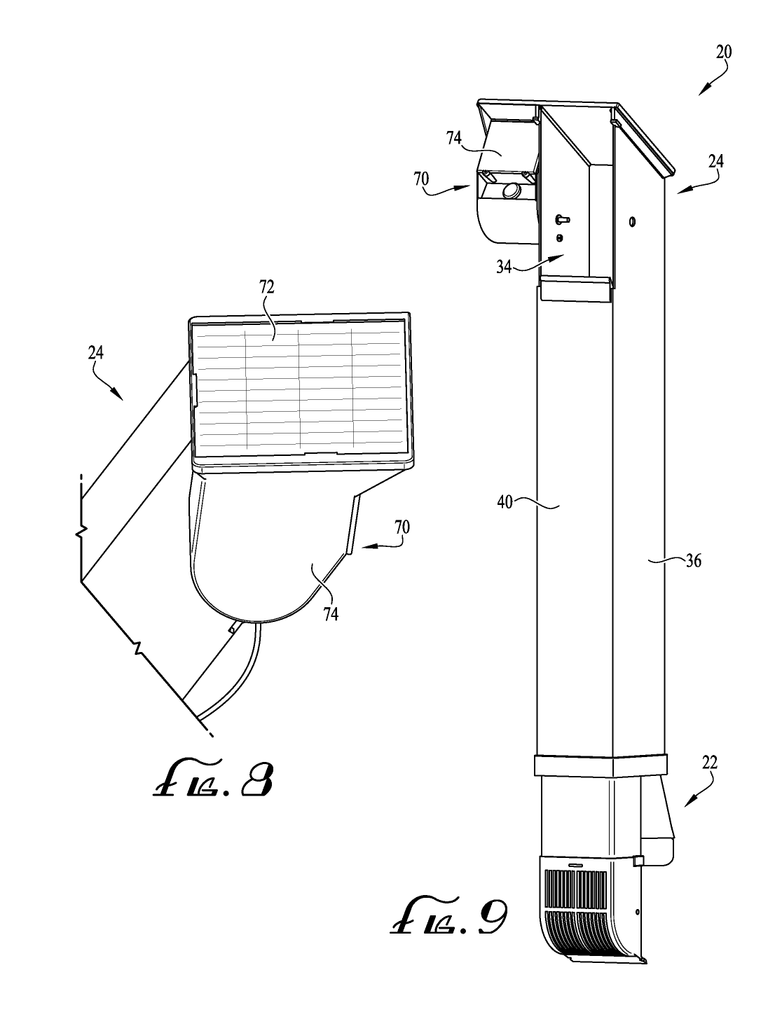

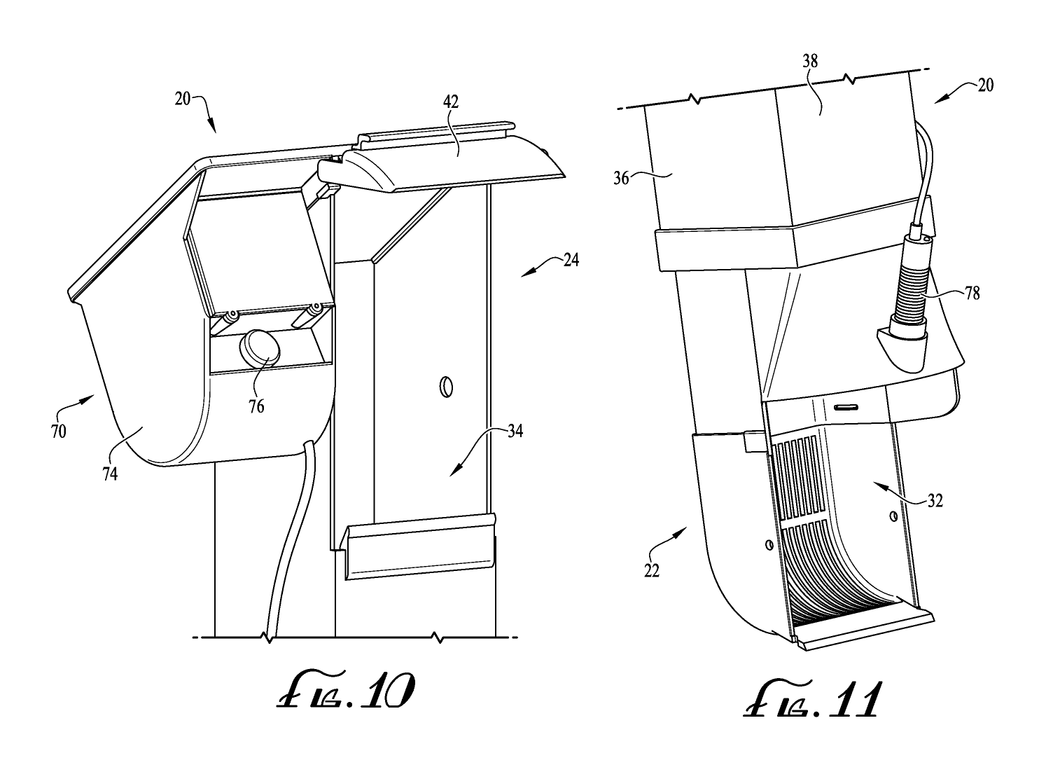

With reference now to the drawing figures, wherein like reference numbers represent corresponding parts throughout the several views, FIGS. 1-16 show a leaf removal conveyor device 10 for a pool skimmer according to an example embodiment of the present invention. The leaf removal conveyor device 10 generally includes a conveyor housing 20 and a collection container 80. The conveyor housing 20 is configured to be partially inserted into a skimmer access opening O of a pool deck D when in use, as shown in FIGS. 1-4. The conveyor housing 20 transports leaves and other debris L from the skimmer S and deposits them in the collection container 80. The leaves L enter the conveyor housing 20 in the bottom portion of the housing that is inserted into the pool skimmer S. The leaves L exit the conveyor housing 20 at or near the top of the housing and are deposited in the collection container 80. The collection container 80 can be removably attached to the conveyor housing 20 so that it can be emptied of leaves and debris L. When not in use, the conveyor device 10 can be removed from the skimmer S and stored.

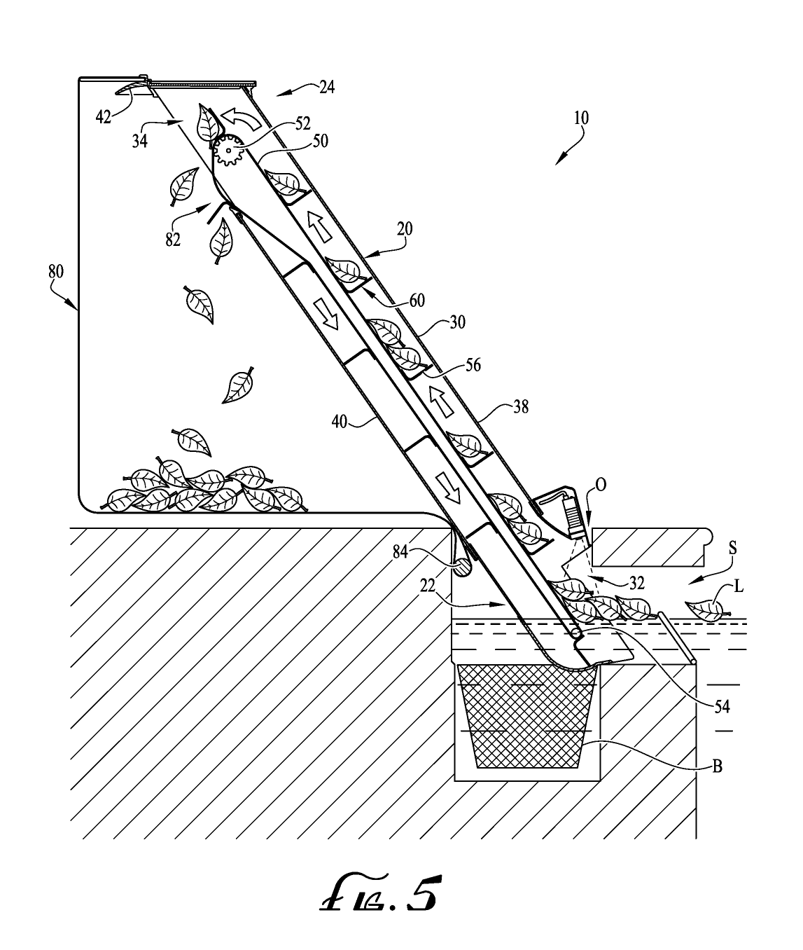

As shown in FIG. 5, the bottom 22 of the conveyor housing 20 is configured to extend through an access opening O in a pool deck D. The bottom 22 of the conveyor housing 20 rest on or just above the front edge of the skimmer basket B such that it will intercept leaves L entering the skimmer S. The top 24 of the conveyor housing 20 extends out of the skimmer S and above the pool deck D. The conveyor housing 20 generally includes a belt 50 and a drive mechanism 70 at least partially surrounded by an outer shell 30. The outer shell 30 includes a bottom or intake opening 32 positioned at the bottom 22 of the conveyor housing. Leaves and other debris L enter the conveyor housing 20 through the intake opening 32. The outer shell 30 also includes a top or exit opening 34 positioned at the top 24 of the conveyor housing 20. Leaves and other debris L exit the conveyor housing 20 through the exit opening 34. The belt 50 is configured to move leaves and debris L that enter the skimmer S through the intake opening 32, through the conveyor housing 20, out the exit opening 34, and into the collection container 80. The drive mechanism 70 is configured to drive the belt 50.

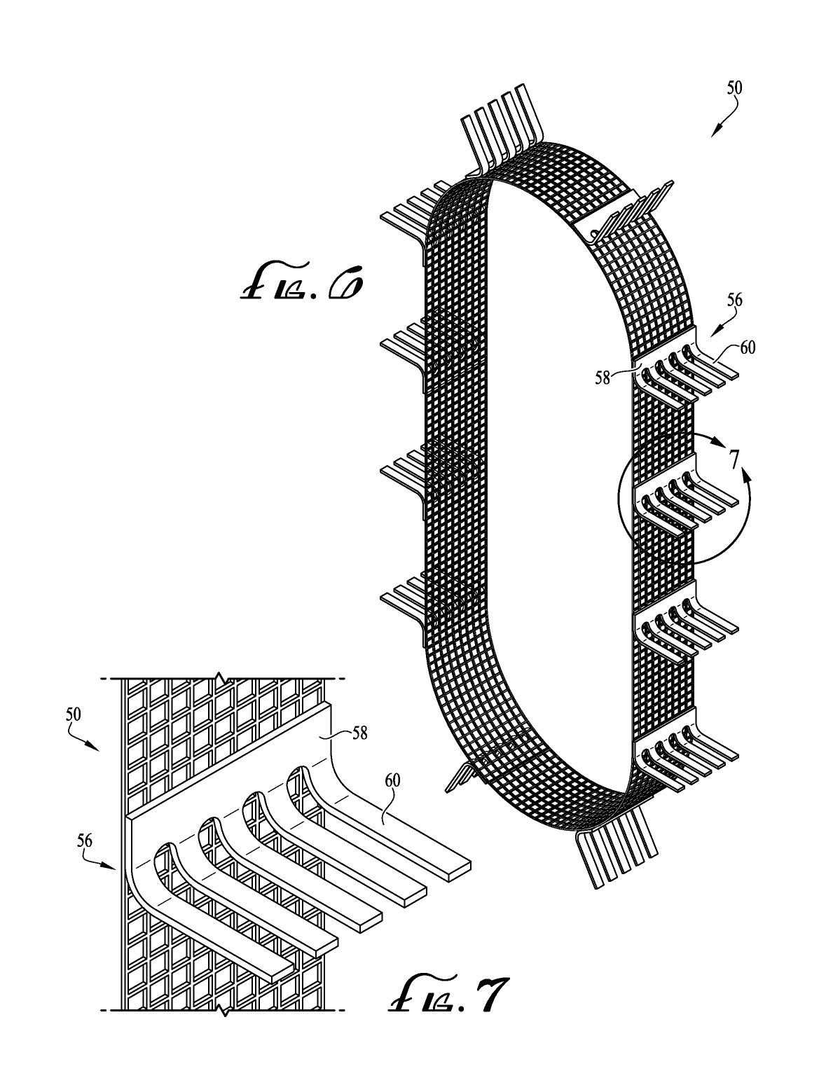

The outer shell 30 of the depicted embodiment is a substantially rectangular-shaped shaft. The shell 30 includes lateral side walls 36 extending the length of the conveyor housing 20. The shell also includes a front wall 38 and a back wall 40. The intake opening 32 is generally formed in the front wall 38 of the outer shell 30 and the exit opening 34 is generally formed in the back wall 40. The outer shell 30 is dimensioned to fit through a skimmer access opening O. The bottom 22 of the shell 30 is designed to rest on the rim of the skimmer basket B or rest on the floor of the skimmer S just above the skimmer basket. In the depicted embodiment, the conveyor device 10 is used without removal of the skimmer basket B. The conveyor device 10 can be used when the skimmer basket is removed because the device itself is designed to prevent the majority of debris from entering the pool pump while maintaining water flow to the pool pump (discussed further below). Generally, a portion of the conveyor housing 20 sits below the water line of the pool. The belt 50 of the depicted embodiment, shown in FIGS. 6-7, extends substantially the length of the conveyor housing 20 between an upper drive sprocket 52 positioned near the upper opening 34 and a bottom roller 54 positioned near the lower opening 32. The belt 50 is configured to move in a cyclical or circular, rotational motion, as indicated by the arrows in FIG. 5. In the depicted embodiment, the belt 50 is constructed of a loose mesh material. The mesh material is configured to allow water to pass through the belt 50, but the mesh material will collect leaves and other debris L. The mesh can be formed of a plastic or another durable material. In example embodiments, the belt is formed from a geo grid or polyethylene mesh material. In example embodiments, the mesh includes openings of between about one forth of an inch and one inch.

As shown in FIG. 7, the belt 50 of the depicted embodiment includes at least one lifting component or cleat 56 to help lift the leaves L through the conveyor housing 20. In the depicted embodiment, the belt 50 includes a series of cleats 56 evenly spaced on the belt. The cleats 56 are shaped to scoop or lift debris L out of the skimmer S as the belt moves in a circular motion. In the depicted embodiment, the cleats 56 are substantially L-shaped with a first surface 58 attached to the belt and a second surface 60 extending outward from the belt. The second surface 60 forms a lifting surface that is generally parallel to the belt 50 and is configured for lifting leaves and debris L. In other embodiments, the cleats 56 are V-shaped such that the second surface 60 is angled relative to the belt 50 such that the cleats carry leaves L in a near vertical position as they travel up the conveyor housing. In alternative embodiments, the cleats 56 are molded 50 with the belt to form an integral component.

In the depicted embodiment, the second surface 60 is formed from an array of evenly spaced teeth that allow water to drain from the leaves L as they are lifted through the housing 20. The cleats 56 can also be formed from a solid sheet including drainage holes or can be constructed of a perforated material to allow water to pass through. The cleats 56 are generally formed from a plastic material. The cleats 56 have a degree of flexibility to prevent them from getting caught on the skimmer or skimmer basket but are rigid enough to support the weight of the leaves and debris. The cleats 56 are configured to deposit the leaves L through the upper opening 34 as they rotate around the drive sprocket 52 at the top of the conveyor housing 20.

The drive mechanism 70 generally includes an electric motor connected to at least one drive sprocket 52 configured to drive the belt 50 in a circular motion. In the depicted embodiment, the conveyor device 10 includes a drive sprocket 52 positioned at the top 24 of the conveyor housing 20. The electric motor can be a 12 volt system configured to turn the sprocket 52 at a rate of about 30 rotations per minute (rpm). In alternative embodiments, a higher or lower voltage electric motor is used. In other embodiments, the conveyor device 10 includes an additional sprocket positioned at the bottom 22 of the conveyor housing 20. The sprocket 52 includes an array of teeth design to engage with the openings in the mesh belt 50 to drive the belt in a circular motion. The sprocket 52 does not require the belt 50 be in tension around the sprocket for the sprocket's teeth to engage the belt. A lack of tension in the belt 50 allows the cleats 56 to move inward when traveling inside the outer shell 30.

In example embodiments, the electric motor 70 is powered by batteries contained within the conveyor housing 20 or with a conventional electric plug. The batteries can be rechargeable. In example embodiments, a 5 Ahr SLA rechargeable battery is used. In the depicted embodiment, the batteries are recharged by a solar panel 72 positioned near the top of the conveyor housing 20. The solar panel can be a 12-18 volt solar panel. In example embodiments, the solar panel 72 is positioned parallel to the pool deck D when the conveyor device 10 is in the use position. In other embodiments, the solar panel 72 is positioned at an angle relative to the pool deck D when the conveyor device 10 is in the use position. In still other embodiments, the solar panel 72 is repositionable such that it can be angled toward the sun light. In other embodiments, the batteries can be electrically recharged. The electric motor and controls for the drive mechanism 70 can be contained in a drive housing portion 74 attached to the outer shell 30.

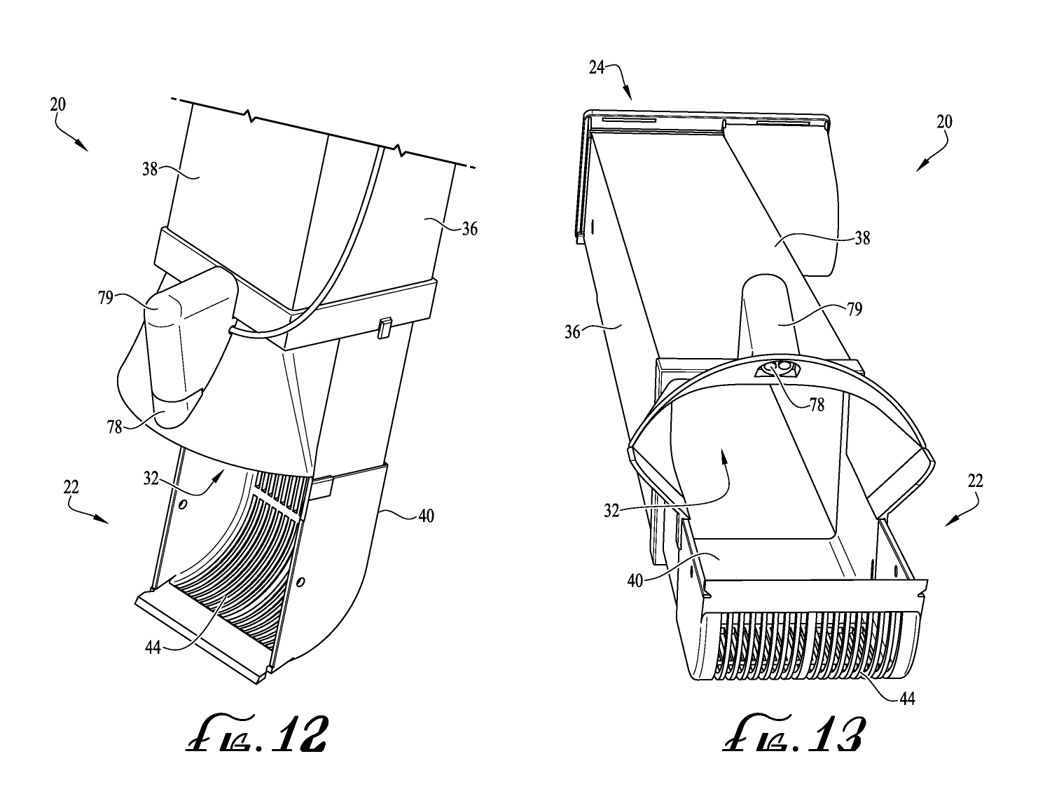

The intake or bottom opening 32 of the outer shell 30 is shown in detail in FIGS. 12-14. In example embodiments, the portion of the back wall 40 of the outer shell 30 positioned behind the intake opening 32 is porous. In the depicted embodiment, the porous portion of the back wall 40 includes a series of slots 44 cut into the back wall material. The slots 44 are dimensioned to allow water to pass through, but still allow the back wall 40 to collect leaves and others debris that will be lifted by the cleats 56 of the moving belt 50. The porous portion 44 of the back wall 40 helps to prevent leaves and debris from entering the pool pump that draws water into the skimmer, which can clog the pump, but also helps maintain water flow to the pump. The continuous flow of water to the pump helps prevent pump cavitation. In preferred embodiments, the drive mechanism 70 is activated before enough debris is collected against the porous portion 44 of the back wall 40 to obstruct the flow of water which can lead to pump cavitation.

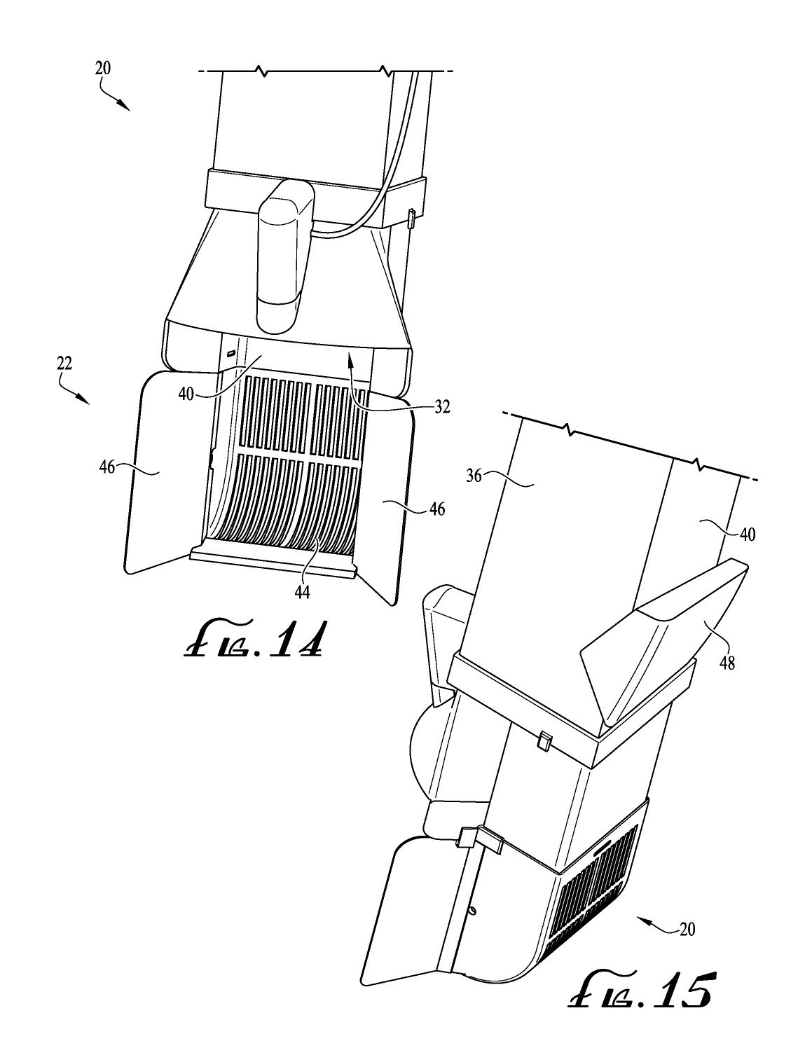

As shown in FIGS. 13 and 14, the intake opening 32 can also include curved wings or scoops 46 mounted to the lateral sidewalls 36 adjacent the opening. The wings 46 are configured to help direct leaves and debris L toward the intake opening 32 so that they can be collected by the cleats 56 of the belt 50. The wings 46 can help prevent the leaves L from bridging or creating a dam in front of the opening 32, preventing the leaves from entering the opening and being removed by the conveyor device 10. In example embodiments, the wings 46 are removably mounted to the lateral sidewalls 36. In this embodiment, the wings 46 can be removed to allow the conveyor device 10 to fit in a skimmer opening O that is too small to fit the conveyor housing with the wings attached. Thus the conveyor housing 10 is customizable to a variety of different skimmer configurations. In the depicted embodiment, the end of the conveyor housing 20 is curved or radiused to match the path of the cleat as it circles the bottom roller.

The drive mechanism 70 can include a control circuit or system to manage the operation of the motor. The drive mechanism 70 can include a simple on/off switch or button 76. Preferably, the control system is configured to remove leaves and debris L at a sufficient rate to prevent the debris from blocking the slots 44 or porous portion in the back wall 40 behind the intake opening 32. In one embodiment, the control mechanism can be configured to run the drive mechanism 70 continuously when it is turned on. This embodiment helps to prevent a blockage of the porous back wall 44, but requires continuous use of energy. In other embodiments, the drive mechanism 70 can be designed to run intermittently to save energy and time between battery charged, but still prevent a blockage of the porous back wall 44. In the depicted embodiment, the drive mechanism 70 includes a sensor 78 configured to detect when leaves and debris L are present in the skimmer S. In example embodiments, the sensor 78 is a visual sensor configured to activate the drive mechanism 70 when the visual sensor “sees” leaves in the skimmer S. An example visual sensor 78 includes a PNP infrared photoelectric sensor. The visual sensor 78 is configured to activate a programmable relay to turn on the electric motor when it detects leaves L in the skimmer S. When the sensor 78 no longer detects leaves L it signals the relay to turn off the electric motor until it does detect more leaves. The visual sensor 78 can be calibrated to require a certain amount of leaves or debris to be detected before activating the drive mechanism 70. Ideally, the visual sensor 78 does not require the drive mechanism 70 to run continuously but the sensor will activate the drive mechanism before enough debris accumulates to block the porous portion 44 of the back wall 40.

As shown in FIGS. 11-14, the visual sensor 78 can be mounted to the front wall 38 of the outer shell 30 near the bottom 22 of the conveyor housing 20. The visual sensor 78 is positioned to be pointed at the skimmer S when the conveyor device 10 is in the use position. In example embodiments, the visual sensor 78 includes a cover 79 attached to the front wall 38 and configured to cover and protect the visual sensor 78. The cover 79 also helps to shield the sensor from ambient light and prevent false positives from reflections off the water or pool deck. In other embodiments, other types of sensors can be used. In alternative embodiments, the drive mechanism 70 can include a timer that is configured to run the drive mechanism at prescribed intervals. For example, the drive mechanism 70 could be programmed to run for five minutes every hour. The time intervals are calibrated to preserve energy while preventing blockage of the porous portion 44 of the back wall 40.

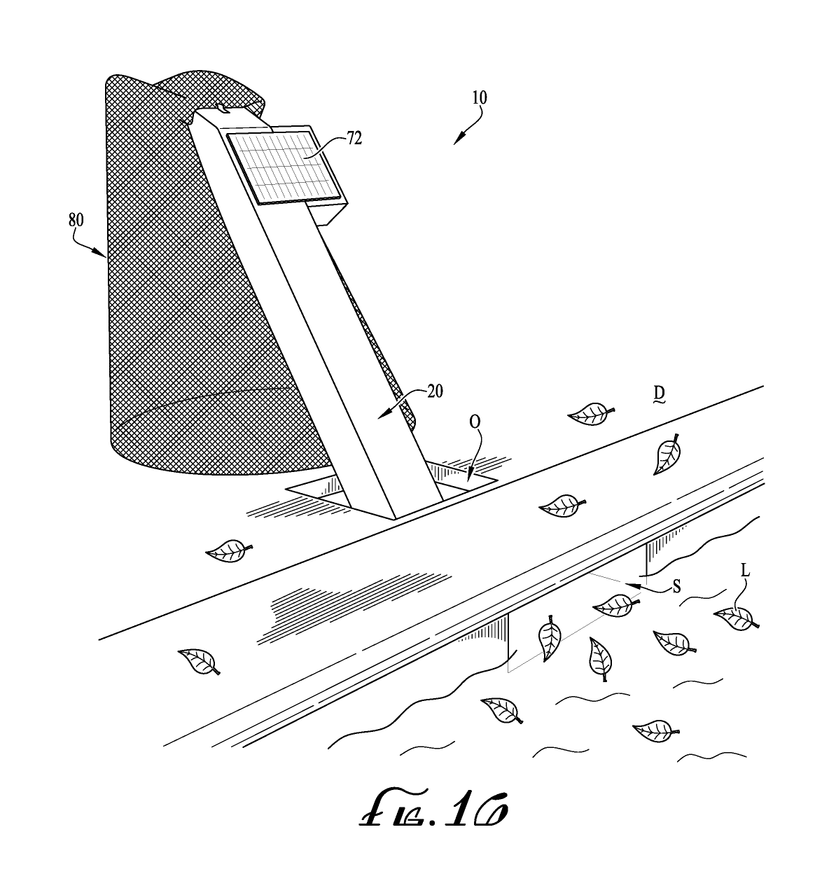

The conveyor housing 20 can optionally include a positioning wedge 48 configured to help hold the conveyor housing in the optimal position within the skimmer S. The wedge 48, shown in FIG. 15 is configured to rest between the back wall 40 of the conveyor housing 20 and the pool deck D. In preferred embodiments, the wedge 48 is customizable such that the conveyor housing 20 is able to be held at the optimal use position in a variety of differently dimensioned skimmers. In an example embodiment, the conveyor device 10 can include a single wedge 48 configured to engage with different positions along the back wall 40 to customize the angle of the conveyor housing 20. In other embodiments, the conveyor device 10 can include a series of different size wedges 48 that correspond to different models or configurations of pool skimmers S. In still other embodiments, the wedge 48 can be shaped such that its orientation relative to the back wall 40 of the conveyor housing 20 provides different positioning of the conveyor housing.

The collection container 80 is positioned to collect the debris L as it exits the upper opening 34. The collection container 80 is generally removably attached to the back wall 40 of the conveyor housing. The collection container 80 is designed to be detached from the conveyor housing 20, emptied, and reattached such that it is reusable. In the depicted embodiment, the collection container 80 has a trapezoidal shape with an opening 82 configured to align with the upper opening 34 of the conveyor housing 20. In other embodiments, the collection container 80 can have another shape. In example embodiments, the exit opening 34 of the conveyor housing 20 includes a scoop protrusion 42 extending from the top of the exit opening. The scoop protrusion 42 is configured to direct the leaves L out of the exit opening 34 and downward into the collection container 80. The collection container or bag 80 is generally formed from a mesh or other perforated material that allows water to drain from the leaves and debris L.

In example embodiments, the bag 80 is formed from a material sufficient for the bag to be continuously reusable. In other embodiments, the bag 80 can be formed from a less durable and cheaper material that is designed to be disposable. In this embodiment, the bag 80 would be detached from the conveyor housing 20 when full and the bag and debris L would be thrown out. A new, disposable bag 80 would be attached to the conveyor housing 20 for the next use. The collection container 80 can also include a weight 84 attached to the bottom periphery of the collection container and configured to hold down a corner of the collection container, especially when it is empty of debris. In the depicted embodiment, the weight 84 is configured to extend through the skimmer opening O.

In the depicted embodiment, the collection container 80 is a similar height to the conveyor housing 20 in the use position. In other embodiments, the collection container 80 can extend over the front and top of the upper portion 24 of the conveyor housing 20. This collection container 80 allows a greater volume of debris to be collected before the container needs to be emptied. In another embodiment, the collection container 80 surrounds the top portion of the conveyor housing 20. This container 80 can also hold a larger volume of debris before the container 80 needs to be emptied. The collection container 80 can also include an open top which allows debris to be removed from the container while the container is still attached to the conveyor housing 20.

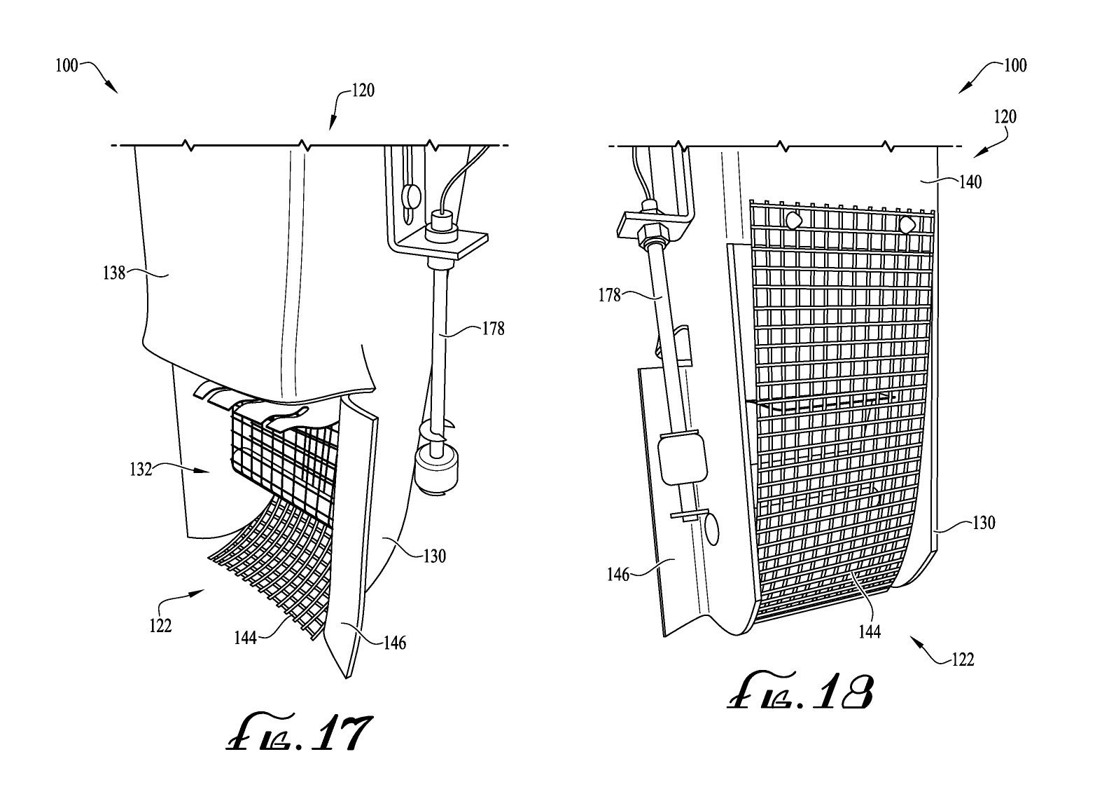

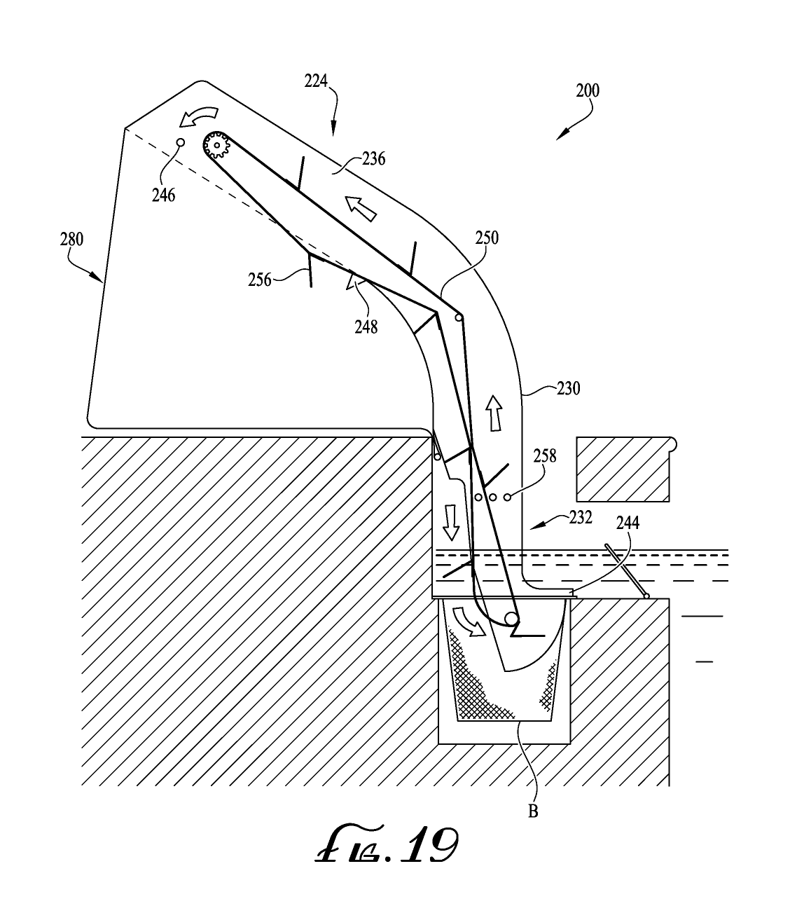

FIGS. 17-18 show a leaf removal conveyor device 100 for a pool skimmer according to another example embodiment of the present invention. The conveyor device includes a conveyor housing 120 substantially similar to the conveyor device 10 of the previous embodiment. However, in the depicted embodiment, the lower, intake opening 132 extends through both the front wall 138 and back wall 140 of the outer shell 130. In example embodiments, the back of the intake opening 132 includes a porous screen 144 attached to the back wall 140 of the conveyor housing 120. The screen 144 is configured to substantially cover the back of the intake opening 132. In the depicted embodiment, the back screen 144 is formed from a mesh material. Like the back wall of the previous embodiment, the back screen 144 is dimensioned to allow water to pass through, but the screen with collect leaves and other debris.

Similar to the previous embodiment, the conveyor device 100 also includes a sensor 178 configured to active the drive mechanism when leaves and debris are detected in the skimmer. In the depicted embodiment, the sensor 178 is a float switch. The float switch 178 is positioned behind a wing 146 on the lateral sidewall 136 of the conveyor housing 120. In other embodiments, alternate positions for the float switch 178 can be used. The float switch 178 is configured to detect drops in the water level within the skimmer. In use, the bottom 122 of the leaf conveyor device 100 is configured to collect leaves and debris until water can no longer pass through the back screen 144. The collected debris creates a dam which will create a drop in water level in the skimmer. The float switch 178 is configured to activate the drive mechanism when the water level drops to a prescribed level. The drive mechanism can be programmed to run for a prescribed time interval after activation or can be configured to stop running when the float sensor 178 detects the water level in the skimmer returns to a higher or normal level. In example embodiments, the float sensor 178 includes a delay relay that allows the drive mechanism to continue running for a predetermined amount of time after the float sensor 178 detects that the water level has return to a normal level.

FIG. 19 shows a leaf removal conveyor device 200 for a pool skimmer according to another example embodiment of the present invention. The conveyor device 200 includes a belt 250 and drive mechanism substantially similar to previous embodiments. However, in the depicted embodiment, the upper portion 224 of the conveyor housing 220 is curved, rather than extending straight out of the skimmer opening as in previous embodiments. This embodiment lowers the height of the overall conveyor device 200 which will help to not obstruct views from the pool. This configuration can also allow for a larger collection container 280. In example embodiments, a decorative cover (not pictured) can be placed over all or a portion of the conveyor device 200. For example, the upper portion of the conveyor housing 220 can depict a dolphin.

In the depicted embodiment, the conveyor housing 220 is configured such that the lower portion of the outer shell 230 rest within the skimmer basket B in the use position. The bottom of the outer shell 230 includes notches 244 positioned on the lateral sidewalls 236. The notches 244 are positioned to engage with the rim of the skimmer basket B while a portion of the conveyor housing 220 extends into the skimmer basket, as shown in FIG. 19. The portion of the outer shell 230 positioned within the skimmer does not include a front or back wall, creating an open bottom section 232. The open bottom section 232 allows water within the skimmer to pass through the open bottom section from the front of the conveyor housing 220 to the back of the conveyor housing. In the depicted embodiment, leaves and debris L collect in the skimmer basket B. The cleats 156 then scoop the leaves L from the skimmer basket B as the belt moves in a circular motion, as indicated by the arrows in FIG. 19. In example embodiments, the conveyor device 200 can empty between one third and two thirds of the skimmer basket B. In this embodiment, the conveyor device 200 can empty leaves and debris already collected by the skimmer basket B.

The conveyor housing 220 of this embodiment can include a cleat clearing post 246 attached to the lateral side walls 236 above the upper drive sprocket 252. The cleat clearing post 246 is positioned to engage with the cleats 256 as they pass to help clear leaves L from the cleat. The clear clearing post 246 is positioned such that as the leaves L are cleared from the cleat, they fall through the upper opening 234 into the collection container 280. The outer shell 230 can also include a cleat retractor 248 positioned on the bottom edge of the upper opening 234. In the example embodiment, the belt 250 and cleats 256 can extend through the upper opening 234 to help deposit leaves L in the collection container 280 The cleat retractor 248 helps push or guide the cleats 256 back into the outer shell 230 as they travel past the bottom of the exit opening 236 and toward the skimmer basket.

The conveyor housing 220 can also include at least one bite control pin 258 configured to adjust how far the cleats 256 extend into the skimmer as they exit the skimmer basket B. In the depicted embodiment, the conveyor housing 220 includes a series of bite control pins 258 positioned above the skimmer basket B. The belt 250 travels between or around the bite control pins 258 which direct the trajectory of the belt and therefore the attached cleats 256. The belt 250 can be adjusted to pass through or around different bite control pins 258 to adjust how far the cleats 256 extend into the skimmer. Adjustment of the bite control pin or pins 258 can be used to prevent jamming and clogging of the leaf removal conveyor.

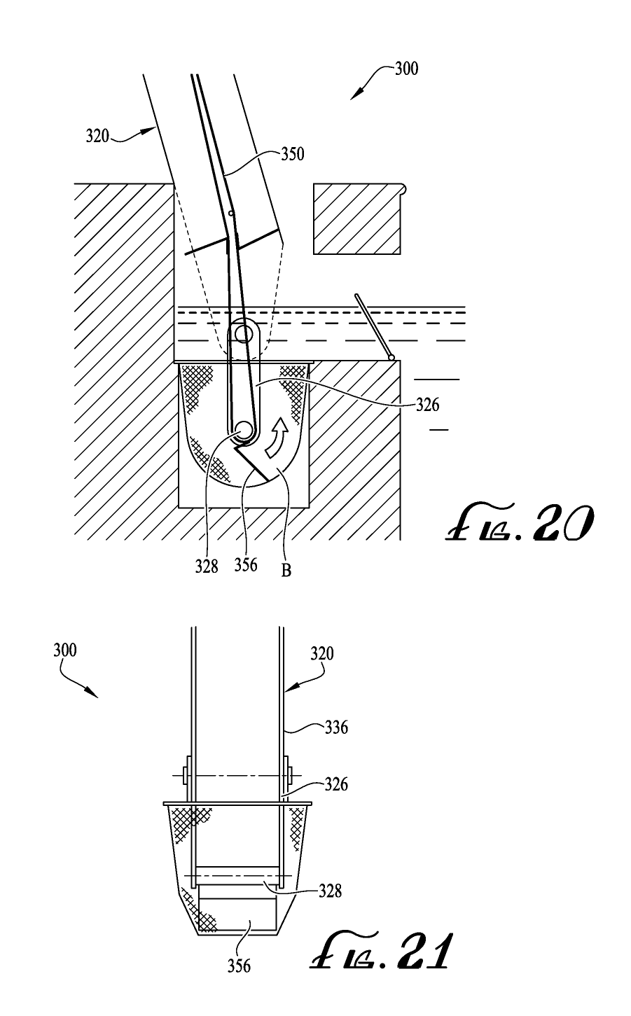

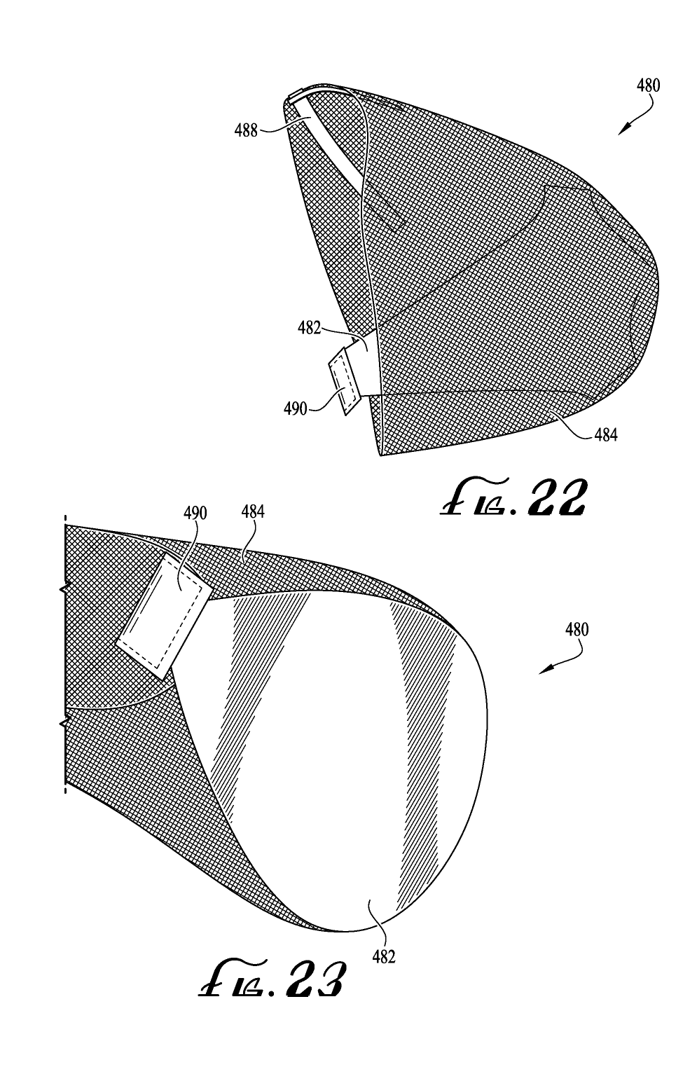

FIGS. 20-21 show a leaf removal conveyor device 300 for a pool skimmer according to another example embodiment of the present invention. In this example embodiment, the conveyor housing 320 includes an extension 326 attached to the bottom of the lateral sidewalls 336 of the outer shell 330. The bottom of the extension 326 includes a roller 328. The belt 350 extends around the roller 328 at the bottom of the extension 326. In previous embodiments, the bottom roller is positioned at the near bottom of the conveyor housing. The depicted embodiment allows the cleats 256 on the belt 250 to reach the bottom of the skimmer basket B, as shown in FIG. 20. In example embodiments, the extension 326 is removably attached to the conveyor device 300 such that a user can adjust whether the belt extends further into the basket B. The length of the extension 326 can also be adjustable such that a user can adjust the length to fit a variety of sizes of skimmer baskets B.

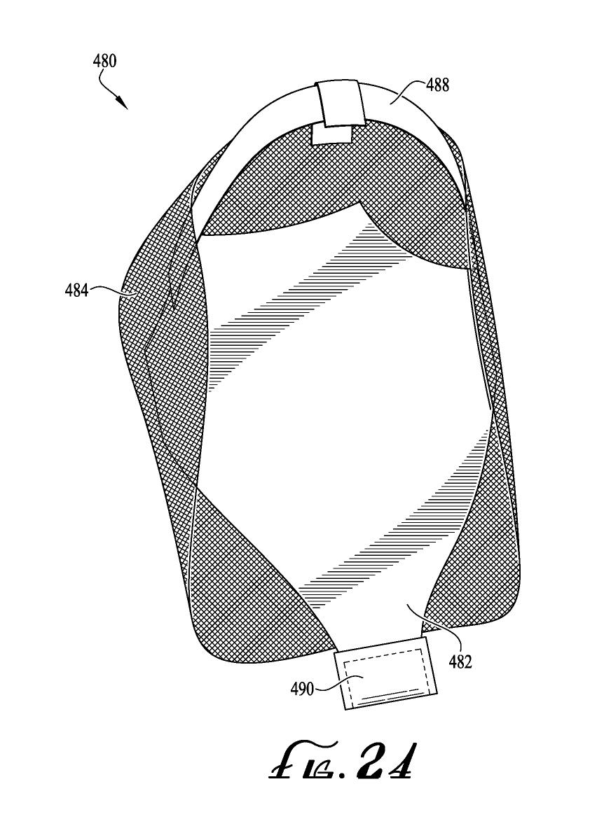

FIGS. 22-24 show a collection container 480 for a leaf removal conveyor device for a pool skimmer according to another example embodiment of the present invention. In the depicted embodiment, the collection container 480 is formed from a triangle shaped bag including a solid floor panel 482 and mesh sidewalls 484 with an opening 486. The bag 480 can include straps 488 that removably engage with hooks or other attachment mechanisms on the conveyor housing. When the bag 480 is attached to the conveyor housing, the opening 486 in the bag aligns with the upper opening in the outer shell. The bag 480 also includes a weight 490 attached to the floor panel 482. The weight 490 helps to hold down the bag 480, especially when it is empty. When the leaf removal conveyor is in use, debris is deposited through the upper opening of the conveyor housing into the bag 480. The bag can be removed to be emptied of debris and reused.

While the invention has been described with reference to example embodiments, it will be understood by those skilled in the art that a variety of modifications, additions and deletions are within the scope of the invention, as defined by the following claims.

What is claimed is:

1. A leaf removal conveyor system for use with a pool skimmer comprising a skimmer basket, the leaf removal conveyor comprising:
a belt including at least one cleat configured to move in a cyclical motion within an enclosure, at least a portion of the enclosure configured to engage with a pool skimmer; and
a drive mechanism configured to move the belt in a cyclical motion moving the at least one cleat through the skimmer to collect and remove debris.

2. The leaf removal conveyor of claim 1, wherein the belt is formed of a mesh material.

3. The leaf removal conveyor of claim 1, wherein the drive mechanism is connected to one or more sprockets, wherein the one or more sprockets are positioned to engage the belt.

4. The leaf removal conveyor of claim 1, further comprising a collection container positioned to collect debris removed from the skimmer.

5. The leaf removal conveyor of claim 1, wherein the drive mechanism operates the belt intermittently based on a prescribed time interval.

6. The leaf removal conveyor of claim 1, wherein the drive mechanism includes a sensor configured to detect debris within the skimmer.

7. The leaf removal conveyor of claim 6, wherein the sensor is a visual sensor.

8. The leaf removal conveyor of claim 6, wherein the sensor is a float sensor.

9. The leaf removal conveyor of claim 1, wherein the drive mechanism is powered by a rechargeable battery.

10. The leaf removal conveyor of claim 9, wherein the rechargeable battery is charged by a solar panel.

11. A leaf removal conveyor system for use with a pool skimmer comprising a skimmer opening and skimmer basket, the leaf removal conveyor comprising:
a conveyor housing configured to extend through the skimmer opening wherein a portion of the conveyor housing rests on a rim of the skimmer basket and a portion of the conveyor housing is positioned within the skimmer basket;
a belt including at least one cleat configured to move in a circular motion within the conveyor housing; and
a drive mechanism configured to move the belt in a cyclical motion moving the at least one cleat through the skimmer basket to collect and remove debris.

12. The leaf removal conveyor system of claim 11, further comprising a collection container configured to collect debris removed from the skimmer basket.

13. The leaf removal conveyor system of claim 11, wherein the conveyor housing includes a front wall, a back wall, and two lateral sidewalls.

14. The leaf removal conveyor system of claim 13, further comprising an intake opening extending through at least the front wall of the conveyor housing.

15. The leaf removal conveyor system of claim 14, wherein a portion of the back wall of the conveyor housing opposite the intake opening is perforated.

16. The leaf removal conveyor system of claim 11, wherein the belt is formed from a mesh material.

17. The leaf removal conveyor system of claim 16, wherein the drive mechanism comprises at least one sprocket configured to engage the mesh material of the belt.

18. The leaf removal conveyor system of claim 11, further comprising an extension attached to the bottom of the conveyor housing, wherein the belt travels around a roller at the bottom of the extension.

19. The leaf removal conveyor system of claim 14, further comprising wings attached to the lateral sidewalls adjacent to the intake opening.

20. A method of removing leaves and debris from a pool skimmer having a skimmer opening and a skimmer basket comprising:
inserting a conveyor housing through the skimmer opening into the skimmer, the conveyor housing comprising a belt with at least one cleat, a drive mechanism, and a sensor configured to determine when leaves and debris are present in the skimmer;
sending a relay signal from the sensor to the drive mechanism when leaves and debris are detected in the skimmer;
having the relay signal activate the drive mechanism to turn the belt in a circular motion wherein the cleats remove the debris from the skimmer; and
collecting the debris removed from the skimmer in a collection container.

21. A leaf removal conveyor system for use with a pool skimmer, the leaf removal conveyor comprising:
an elongate housing having a intake opening in a bottom end of the housing and an exit opening in the top end of the housing, wherein the bottom end of the housing is configured to be inserted into the pool skimmer, and wherein a portion of the housing behind the intake opening is perforated;
a belt including at least one cleat configured to move in a circular motion within the housing; and
a drive mechanism configured to move the belt moving the at least one cleat through the skimmer to collect and remove debris.
